(19) United States
(12) Patent Application Publication
(10) Pub. No.: US 2026/0095318 A1
(43) Pub. Date: Apr. 2, 2026

(54) CBRS GAA Interference Mitigation

(71) Applicant: Apple Inc., Cupertino, CA (US)

(72) Inventors: Alexander SIROTKIN, Hod Hasharon (IL); Fangli XU, Beijing (CN); Haijing HU, Los Gatos, CA (US); Naveen Kumar R PALLE VENKATA, San Diego, CA (US); Peng CHENG, Beijing (CN); Ping-Heng KUO, London (GB); Ralf ROSSBACH, Munich (DE); Yuqin CHEN, Beijing (CN); Zhibin WU, Los Altos, CA (US)

(21) Appl. No.: 19/113,274

(22) PCT Filed: Sep. 19, 2023
(86) PCT No.: PCT/US2023/033115

§ 371 Date: Mar. 19, 2025

Related U.S. Application Data
(60) Provisional application No. 63/376,801, filed on Sep. 23, 2022.

(51) Int. Cl. H04L 9/08; H04B 17/318; H04L 27/26; H04W 24/10

(52) U.S. Cl. CPC H04L 9/088; H04B 17/328; H04L 27/2656; H04W 24/10

(57) ABSTRACT

A user equipment (UE) configured to decode, based on signals received from a first cell of a network, network configuration information, wherein the first cell is operated by a first base station and deployed on a portion of spectrum that utilizes a shared tiered access and authorization framework, collect measurement data corresponding to a second cell, the second cell operated by a second base station and deployed on the portion of the spectrum that utilizes the shared tiered access and authorization framework, wherein the first base station and the second base station are deployed by different network operators and are part of a same tier within the shared tiered access and authorization framework and configure transceiver circuitry to report the measurement data to the network.

### PRIORITY/INCORPORATION BY REFERENCE

This application claims priority to U.S. Provisional Application Ser. No. 63/376,801 filed on Sep. 23, 2022 and entitled “CBRS GAA Interference Mitigation,” the entirety of which is incorporated herein by reference.

### BACKGROUND

Citizens Broadband Radio Service (CBRS) is 150 MHz of spectrum (from 3.55 to 3.7 GHZ) in the 3.5 GHz band (“Band 48”) and may be used by various types of operators to deploy wireless communication networks. CBRS access is based on a multi-tier access and authorization framework comprising tier 1 (incumbent access), tier 2 (priority access license (PAL)) and tier 3 (general authorized access (GAA)). Incumbent access users are to be protected from harmful interference caused by PAL users and GAA users. PAL users are to be protected from harmful interference caused by GAA users. Thus, GAA users are to protect incumbent access users and PAL users from harmful interference. However, GAA users have no expectation of interference protection from other GAA users. It has been identified there is a need for mechanisms configured to identify and/or mitigate interference between GAA users.

### SUMMARY

Some exemplary embodiments are related to an apparatus of a user equipment (UE), the apparatus having processing circuitry configured to decode, based on signals received from a first cell of a network, network configuration information, wherein the first cell is operated by a first base station and deployed on a portion of spectrum that utilizes a shared tiered access and authorization framework, collect measurement data corresponding to a second cell, the second cell operated by a second base station and deployed on the portion of the spectrum that utilizes the shared tiered access and authorization framework, wherein the first base station and the second base station are deployed by different network operators and are part of a same tier within the shared tiered access and authorization framework and configure transceiver circuitry to report the measurement data to the network.

Other exemplary embodiments are related to an apparatus of a base station, the apparatus having processing circuitry configured to configure transceiver circuitry to transmit configuration information to a user equipment (UE), wherein the first base station operates a first cell deployed on a portion of spectrum that utilizes a shared tiered access and authorization framework and decode, based on signals received from the UE, measurement data corresponding to a second base station, wherein the second base station operates a second cell deployed on the part of the spectrum that utilizes the shared tiered access and authorization framework, wherein the first base station and the second base station are deployed by different network operators and are part of a same tier within the shared tiered access and authorization framework.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a network architecture according to various exemplary embodiments.

FIG. 5 shows a method for Citizens Broadband Radio Service (CBRS) general authorized access (GAA) interference mitigation according to various exemplary embodiments.

FIG. 6 shows a method 600 for CBRS GAA interference mitigation according to various exemplary embodiments.

### DETAILED DESCRIPTION

The exemplary embodiments may be further understood with reference to the following description and the related appended drawings, wherein like elements are provided with the same reference numerals. The exemplary embodiments relate to Citizens Broadband Radio Service (CBRS) general authorized access (GAA) interference identification and mitigation.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network and gNB is merely provided for illustrative purposes. The exemplary embodiments may be utilized with any appropriate type of network and access node.

The exemplary embodiments are further described with regard to CBRS. CBRS refers to 150 MHz of spectrum (from 3.55 to 3.7 GHz) in the 3.5 GHz band (“Band 48”) and may be used to deploy cellular networks with small but concentrated deployments. CBRS access may be based on a multi-tiered access and authorization framework configured to accommodate shared federal and non-federal use of the band. CBRS access may be managed by a Spectrum Access System (SAS) entity that is configured to coordinate operations between users in three different access tiers, e.g., tier 1 (incumbent access), tier 2 (priority access license (PAL)) and tier 3 (general authorized access (GAA)). Incumbent access users (e.g., federal government) may have priority to use the spectrum over priority access users and GAA users. PAL users are licensed to use CBRS and are to protect incumbent users from harmful interference. GAA users may operate through registration and are to protect incumbent users and PAL users from harmful interference. However, GAA users have no expectation of interference protection from other GAA users.

An operator may deploy time division duplexing (TDD) new radio (NR) on CBRS. TDD NR may operate on the assumption of exclusive access to the spectrum. However, even though the operator may assume exclusive access to the spectrum, interference from neighbor cells is still possible (e.g., network planning error, etc.). The interference may be caused by neighbor cells operating in the same frequency range or from cells operating in adjacent frequency ranges when their TDD configurations are not properly aligned, or synchronization is not sufficiently precise.

The exemplary embodiments are further described with regard to a scenario in which two gNBs (e.g., gNB 1 and gNB 2) belonging to different CBRS operators are deployed within a close enough proximity of one another to potentially cause interference. A first gNB (gNB 1) may be a CBRS GAA user that is configured to use a first CBRS GAA frequency range and the second gNB (gNB 2) may be a CBRS GAA user that is configured to use a second CBRS GAA frequency range that overlaps (fully or partially) with the first gNB CBRS GAA frequency range. Alternatively, the second gNB may be a CBRS GAA user that is configured to use a second CBRS GAA frequency range that does not overlap with the first CBRS GAA frequency range but uses a different TDD configuration than the TDD configuration used by the first gNB. In either of the above example scenarios, both operators may experience inadequate performance due to interference. It has been identified that there is a need for mechanisms and techniques configured to identify and/or mitigate the cause of interference.

Under some circumstances, to mitigate the interference between two base stations, cross link interference (CLI) mitigation techniques may be utilized. However, CLI capabilities assume and/or rely on two base stations being able to communicate in a manner that is typically not available to two base stations deployed by different operators for CBRS GAA.

Accordingly, there is a need for mechanisms and techniques related to identifying and/or mitigating interference between CBRS GAA users.

According to some aspects, the exemplary embodiments may utilize UEs to collect information indicating a cause of interference between CBRS GAA users. The exemplary embodiments introduce mechanisms and techniques on the UE side and the network side to enable this type of functionality. Any of the exemplary embodiments described herein may be used in conjunction with other exemplary embodiments, in conjunction with currently implemented interference identification and mitigation techniques, in conjunction with future implementations of interference identification and mitigation techniques, independently from other exemplary embodiments and independently from other interference identification and mitigation techniques.

CBRS primarily refers to a technology which is deployed in the United States on Band 48 (B48 or N48) and use CBRS shared public land mobile networks (PLMN) 315/0100n. While the exemplary embodiments provide benefits to CBRS GAA users, the exemplary embodiments are not limited to GAA users or even CBRS. Any reference to CBRS, GAA and/or CBRS specific entities are provided as non-limiting examples. The exemplary embodiments may be applied to any portion of spectrum that implicates a multi-tiered access and authorization framework where users of the same access tier do not expect interference protection from one another.

Throughout this description, reference to the terms “tiered access and authorization framework” or “shared access and authorization framework” or “shared tiered access and authorization framework” to characterize how users are to access a particular portion of spectrum is intended to encompass the framework used for CBRS. However, the exemplary embodiments are not limited to CBRS and may apply to any portion of spectrum that is shared by different types of users. Therefore, reference to tiered access and authorization framework” or “shared access and authorization framework” or “shared tiered access and authorization framework” may be used apply to the access framework used by any portion of spectrum that implements an access and authorization scheme that is based on a hierarchy of different types of users that may use the spectrum under different conditions.

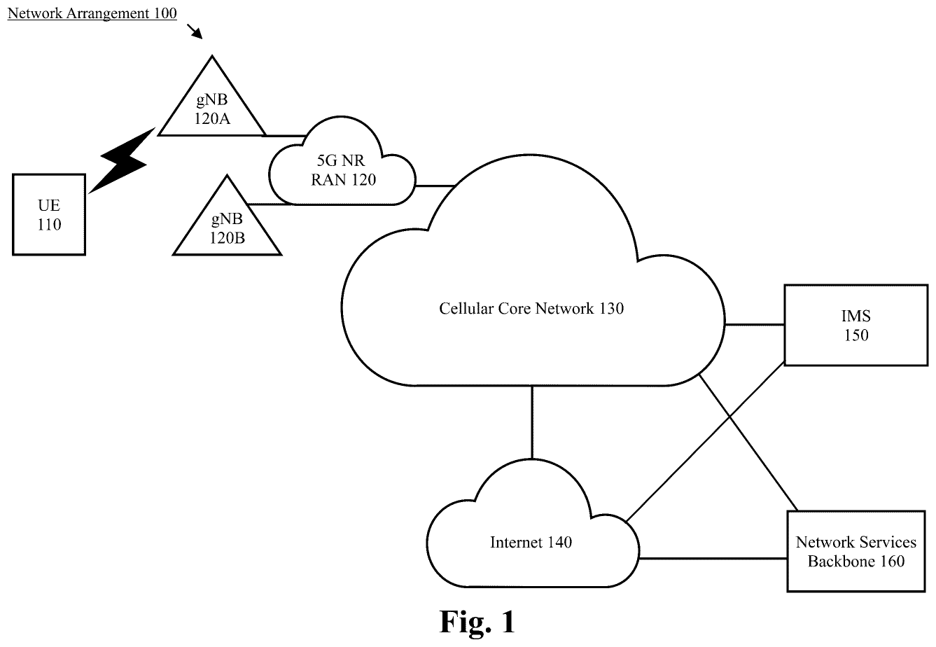

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, a 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A and/or the gNB 120B.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

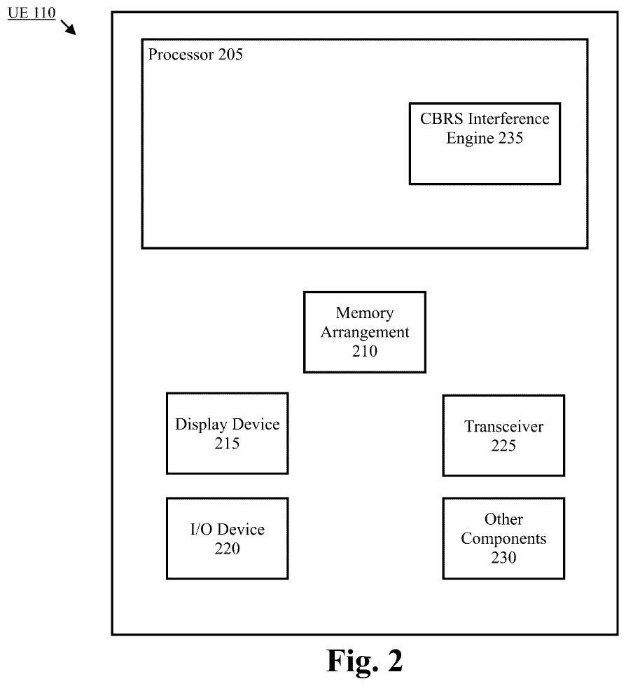

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a CBRS interference engine 235. The CBRS interference engine 235 may perform various operations related to interference identification and mitigation such as, but not limited to, receiving configuration information, collecting measurement data and reporting measurement data.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

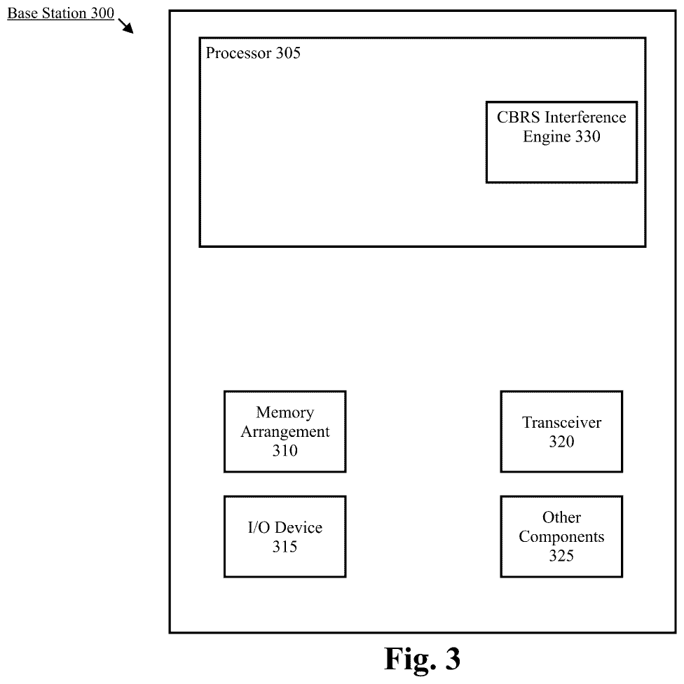

FIG. 3 shows an exemplary base station 300 according to various exemplary embodiments. The base station 300 may represent the gNB 120A, the gNB 120B or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, a CBRS interference engine 330 may perform various operations related to identifying and mitigating interference such as, but not limited to, sending configuration information to UEs, transmitting measurement resources and receiving measurement reports.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

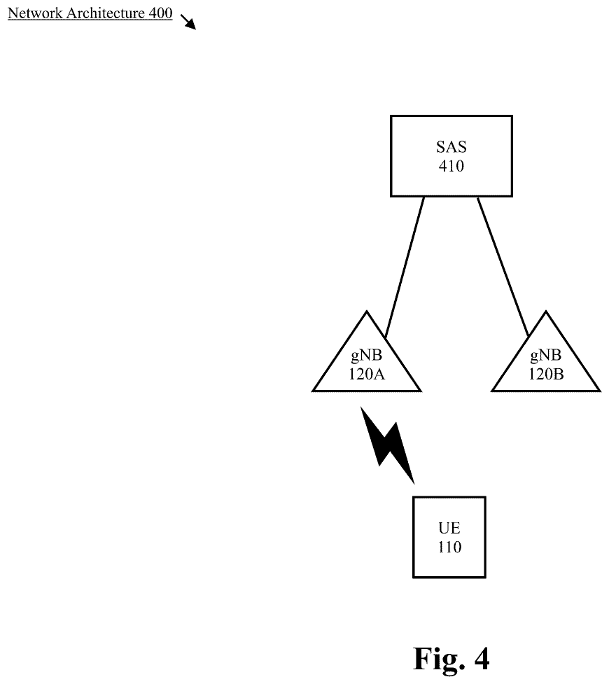

FIG. 4 shows a network architecture 400 according to various exemplary embodiments. The network architecture 400 is described with regard to the network arrangement 100 of FIG. 1.

The network architecture 400 shows the UE 110 and a deployed within the vicinity of the gNB 120A and the gNB 120B which are configured for CBRS operation. In addition, the gNB 120A and the gNB 120B may be deployed by a same network operator or a different network operator. A base station configured for CBRS operations may be referred to as a CBRS device (CBRSD). Thus, in this example, the gNB 120A and the gNB 120B may each be characterized as a CBRSD.

The gNB 120A and gNB 120B may be connected to a SAS 410. Those skilled in the art will understand that the SAS 410 is a network node unique to CBRS and may not be present in 3GPP architecture when it is powered on. The SAS 410 may manage CBRS access and coordinate operations between and among CBRS users in a same access tier or different access tier (e.g., incumbent access, PAL and GAA). The SAS 410 may be configured with the hardware, software, firmware and/or interfaces to exchange information with gNBs, other SASs or any other appropriate entity. The SAS 410 may be a network node running on one or more processors, a cloud-based architecture, a combination thereof or in any other appropriate manner.

During operation, the SAS 410 may receive requests from gNBs to operate 5G NR services on CBRS and either grant or deny the requests. This may include indicating which frequencies can be used by the gNBs and which frequencies are currently being used by users on a higher tier (e.g., incumbent access, PAL). However, reference to a single SAS 410 interfaced with two gNBs 120A, 120B is merely provided for illustrative purposes. In an actual deployment scenario, any appropriate number of SASs may be deployed and configured to communicate with any appropriate number of base stations.

Initially, assume that the gNB 120A and the gNB 120B are both configured for CBRS GAA but deployed by different network operators. The gNB 120A may request and receive access to a first CBRS GAA frequency range from the SAS 410. The gNB 120B may also request and receive access to a second CBRS GAA frequency range from the SAS 410 that overlaps (fully or partially) with the first CBRS GAA frequency range. Alternatively, the first and second BRS GAA frequency ranges may not overlap but utilize different TDD configurations. In this type of scenario, both operators may experience inadequate performance due to interference. Since the SAS 410 is not required to protect CBRS GAA users from one another, the SAS 410 may not consider the possibility of CBRS interference between the gNB 120A and the gNB 120B when allocating the CBRS spectrum. In addition, the gNB 120A and the gNB 120B may not be equipped with an Xn interface to communicate with one another and their respective operators may not have any available mechanisms to enable communication between the two gNBs 120A, 120B. As a result, the operators may not be able to identify the cause of the interference and implement adequate mitigation techniques.

In the examples described below, reference is made to the terms “victim gNB” and “aggressor gNB.” These terms are intended to characterize the effect interference has on two or more gNBs. That is, the term “victim gNB” may be used to identify a base station or access node that is subject to interference from another base station or access node operation. For example, the gNB 120A may be considered a victim gNB if it is subject to interference cause by the operation of gNB 120B. The term “aggressor gNB” may be used to identify a base station or access node that is causing interference for another base station or access node. For example, the gNB 120B may be considered an aggressor gNB if causes interference for gNB 120A. In some deployment scenarios, single gNB may be considered only a victim gNB, only an aggressor gNB or may be both a victim gNB and an aggressor gNB at the same time. However, reference to the terms victim gNB and aggressor gNB are merely provided for illustrative purposes, different entities may refer to a base station or access node under similar conditions by different names.

As will be described in more detail below, the exemplary embodiments may utilize the UE 110 to collect measurement data from an aggressor gNB. The measurement data may indicate a cause of interference on a victim gNB by the aggressor gNB. The UE 110 may then report this information to a network for interference mitigation.

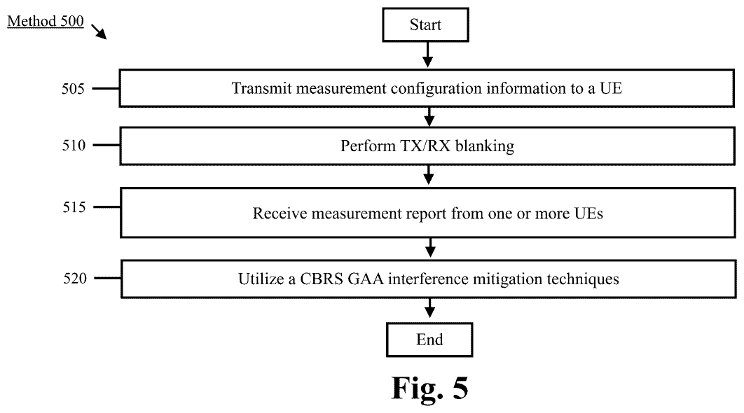

FIG. 5 shows a method 500 for CBRS GAA interference mitigation according to various exemplary embodiments. The method 500 is described from the perspective of the network side and within the context of the network architecture 400 of FIG. 4. After the description of the method 500, the method 600 describes a similar scenario from the perspective of the UE 110.

Initially, assume a scenario in which the gNB 120A is a serving cell for the UE 110 and the gNB 120B is a neighbor cell to the UE 110 deployed by different operators. In addition, the gNB 120A is characterized as a victim gNB and the gNB 120B is characterized as an aggressor gNB.

In 505, the gNB 120A transmits measurement configuration information to the UE 110. The measurement configuration information may be provided to the UE 110 in one or more radio resource control (RRC) messages or in any other appropriate manner.

The measurement configuration information for CBRS GAA interference may include various different types of configuration information. For example, in some embodiments, the configuration information may include thresholds and/or other conditions that are to trigger the UE 110 to collect and report measurement information for CBRS GAA interference. In addition, the configuration information may instruct the UE 110 as to a type of measurement report to be provided and/or the contents of the measurement report to be provided.

In 510, the gNB 120A performs transmission and reception (TX/RX) blanking. TX/RX blanking may comprise a serving gNB configuring a time window during which transmission are not performed by the gNB and uplink transmission are not scheduled by the gNB. Since there is typically no coordination between two interfering gNBs for CBRS GAA operation, it may be difficult to detect a condition other than general abnormal interference using conventional measurements and procedures. However, when a serving victim gNB performs TX/RX blanking for a sufficiently long time window, the UE 110 may collect measurement data and other configuration information that may be used to identify a cause of interference on the serving gNB or at least identify aspects of the interference at a more granular level. For example, during TX/RX blanking the UE 110 may detect other cells operating in the same or adjacent frequency bands as the gNB 120A (e.g., gNB 120B), synchronize with those cells and/or acquire information that would allow the operator of the victim gNB to mitigate the issue.

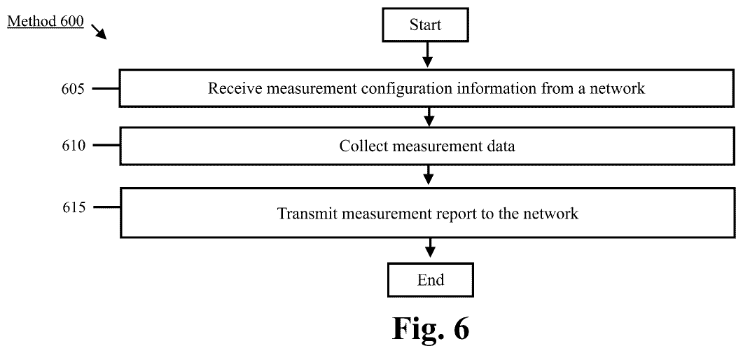

In 515, the gNB 120A receives a measurement report from one or more UEs. The measurement report may include measurement data and/or other configuration information corresponding to an aggressor gNB. The measurement report may indicate to the network the cause of the interference on the victim gNB. Additional details regarding the type of measurement data and information that may be collected and reported by UEs to an operator of a victim gNB is provided below with regard to the method 600 of FIG. 6.

In 520, the network utilizes a CBRS GAA interference mitigation technique. Thus, an operator may detect interference, configure UEs to perform CBRS GAA interference measurements, receive measurement data and other configuration information about one or more aggressor gNBs from the UEs and utilize the information provided by the one or more UEs to implement an interference mitigation technique. In some examples, the gNB 120A may be triggered to request a different portion of the CBRS spectrum from the SAS 410 on which to operate or request that the SAS 410 configure the aggressor gNB 120B to operate on a different portion of the CBRS spectrum. To provide some other non-limiting examples of other CBRS GAA interference mitigation techniques, the operator may consider using CBRS interference mitigation functionality coordinated by one or multiple coexistence managers (CxM) (e.g., a logical entity configured to manage coexistence among CBSDs within a specific coexistence group), encourage the operator of the aggressor cell to consider using CBRS interference mitigation functionality and/or coordinate with the operator of the aggressor cell using some other non-technical means.

FIG. 6 shows a method 600 for CBRS GAA interference mitigation according to various exemplary embodiments. The method 600 is described from the perspective of the UE 110 within the context of the network architecture 400 of FIG. 4.

Like in the description of the method 500, assume a scenario in which the gNB 120A is a serving cell for the UE 110 and the gNB 120B is a neighbor cell to the UE 110 deployed by different operators. In addition, the gNB 120A is characterized as a victim gNB and the gNB 120B is characterized as an aggressor gNB.

In 605, the UE 110 receives measurement configuration information from the network. The measurement configuration information may be provided to the UE 110 in one or more RRC messages or in any other appropriate manner. The measurement configuration information for CBRS GAA interference may include various different types of configuration information. For example, in some embodiments, the configuration information may include thresholds and/or other conditions that are to trigger the UE 110 to collect and report measurement information for CBRS GAA interference. In addition, the configuration information may instruct the UE 110 as to a type of measurement report to be provided and/or the contents of the measurement report to be provided.

In 610, the UE 110 collect measurement data corresponding to one or more aggressor gNBs. For example, the UE 110 may tune away from a serving cell and scan for signals broadcast by other cells (e.g., gNB 120B). The UE 110 may identify the signals and collect measurement data and/or other configuration information corresponding to the aggressor gNB. As mentioned above, on the network side, the gNB 120A may perform TX/RX blanking to reduce active interference experienced by the UE 110 and/or gNB 120B. This may allow the UE 110 to more easily collect measurement data and/or information related from neighbor cells (e.g., aggressor gNB 120B, etc.).

According to some aspects, measurements such as receive signal strength indication (RSSI) may be used determine crosslink interference. In this example, the RSSI may be defined as a linear average of the total received power observed only in the configured orthogonal frequency division multiplexing (OFDM) symbols of the configured measurement time resources in the configured measurement bandwidth from all sources including co-channel serving and non-serving cells, adjacent channel interference, thermal noise, etc. Since RSSI accounts for multiple sources, if there are no transmission on the serving cell when it is measured (e.g., TX/RX blanking) it would account for the interference of the aggressor CBRS GAA cell.

In addition, a subframe number (SFN) and framing time difference (SFTD) between two or more networks may be measured. In this example, the SFTD may be defined as comprising a SEN offset (=SFN of a first cell−SFN of a second cell mod 1024) and a frame boundary offset (=frame boundary of a first cell frame boundary of a second cell/5) where the frame boundary of cell (X) is a time when the UE 110 receives the start of a radio frame from cell (X). The SFTD may be useful for detecting a lack of synchronization between the victim gNB and the aggressor gNB.

The UE 110 may attempt to synchronize with the potential aggressor cell and acquire some information about it. For example, during one or more measurement gaps, the UE 110 may tune to an aggressor gNB to collect measurement data and other configuration information. This may include receiving a system information block (SIB) (e.g., SIB1, etc.) of the aggressor gNB and reading its contents. The type of configuration information that may be collected from the aggressor gNB may include, but is not limited to, a TDD configuration which may be provided in a TDD-UL-DL-configCommon information element (IE) of SIB1 and a bandwidth which may be provided in DownlinkConfigCommon IE of SIB1. In some embodiments, only active bandwidth part (BWP) may be read in SIB1 which may be smaller than the bandwidth the cell can use and thus, measurements collected from multiple UEs may be derived on the network side to help the operator of the victim cell understand the full bandwidth of the aggressor gNB.

According to some aspects, the exemplary embodiments extend the NR measurement framework to allow a gNB to configure UEs to perform and report the following measurements for CBRS GAA interference mitigation. For example, the network may configure measurement objects (e.g., a list of objects on which the UE 110 may perform the measurements) and reporting configurations including reporting criteria, format, trigger conditions (e.g., identify a cell with a different TDD configuration than victim gNB, identify a PLMN with a different PLMN than the victim gNN) and measurement report contents. In addition, the network may configure the UE 110 with measurement identities, quantity configuration (measurement filtering configuration used for all event evaluations and a measurement gap configuration.

Under some circumstances, measurement gaps may be configured for a UE to ensure that the UE does not receive downlink traffic from a serving cell when it tunes away to measure other cells. For CBRS GAA, the measurement gap configuration information may also indicate that during the measurement gap the serving gNB does not perform downlink transmissions or scheduling uplink transmissions on the serving cell (e.g., TX/RX blanking). In addition, the following enhancements are proposed for CBRS GAA interference mitigation. One enhancement includes extending the measurement gap length. For example, the measurement gap length may typically be about 6 millisecond (ms). The exemplary embodiments propose extending the measurement gap length to allow the UE 110 sufficient time to synchronize with the aggressor cell. In some examples, the enhanced measurement gap length may be tens or ms or even longer. Another enhancement includes extending the measurement gap periodicity. For example, the measurement gap periodicity may typically be about 160 ms. The exemplary embodiments propose extending the measurement gap periodicity (e.g., increasing the time between measurement gaps) to reduce the number of times the UE 110 attempts to collect the measurement data. In some examples, the measurement gap periodicity may occur every couple of minutes or event tens of minutes. Since aggressor cells are unlikely to appear frequently, performing GAA interference measurement too often may cause the UE 110 to experience a significant battery drain. Thus, the measurement gap periodicity may be extended to conserver UE power.

In 615, the UE 110 transmits a measurement report to the network (e.g., gNB 120A). The measurement report may include at least in part, measurement data collected from aggressor gNBs. In addition, the UE 110 may report configuration information from aggressor gNBs collected by the UE 110. As described above with regard to the method 500 of FIG. 5, the information reported by the UEs may allow the network operator to implement an appropriate CBRS GAA interference mitigation technique.

### EXAMPLES

In a first example, a method performed by a user equipment (UE), comprising receiving network configuration information from a first cell of a network, the first cell operated by a first base station and deployed on a portion of spectrum that utilizes a shared tiered access and authorization framework, collecting measurement data corresponding to a second cell, the second cell operated by a second base station and deployed on the part of the spectrum that utilizes the shared tiered access and authorization framework, wherein the first base station and the second base station are deployed by different network operators and are part of a same tier within the shared tiered access and authorization framework and reporting the measurement data to the network.

In a second example, the method of the first example, wherein the measurement data comprises receive signal strength indication (RSSI).

In a third example, the method of the first example, wherein the RSSI is a linear average of a total received power observed by the UE in configured orthogonal frequency division multiplexing (OFDM) symbols of configured measurement time resources in a configured measurement bandwidth.

In a fourth example, the method of the first example, wherein the measurement data comprises a subframe number (SFN) and framing time difference (SFTD) between the network and a second different network.

In a fifth example, the method of the first example, wherein the SEN and SFTD is comprised of at least a SFN offset and a frame boundary offset.

In a sixth example, the method of the first example, further comprising receiving a system information block (SIB) from the second base station and reporting configuration information of the second base station derived from the SIB to the network.

In a seventh example, the method of the sixth example, wherein the configuration information of the second base station derived from the SIB includes a time division duplexing (TDD) configuration for the second base station.

In an eighth example, the method of the sixth example, wherein the configuration information of the second base station derived from the SIB includes a bandwidth on which the second base station operates.

In a ninth example, the method of the first example, wherein the UE is triggered to report the measurement data to the network based on identifying that the first base station and the second base station uses a different time division duplexing (TDD) configuration.

In a tenth example, the method of the first example, wherein the UE is triggered to report the measurement data to the network based on identifying that the first base station and the second base station belong to a different public land mobile network (PLMN).

In an eleventh example, the method of the first example, wherein the collecting is performed during a measurement gap that is greater than 6 milliseconds (ms).

In a twelfth example, the method of the first example, wherein the collecting is performed during a measurement gap that is configured with a measurement gap periodicity that is greater than 160 milliseconds (ms).

In a thirteenth example, the method of the first example, wherein the spectrum that utilizes the shared tiered access and authorization framework is citizens broadband radio service (CBRS) and the same tier is general authorized access (GAA).

In a fourteenth example, a processor configured to perform any of the methods of the first through thirteenth examples.

In a fifteenth example, a user equipment (UE) comprising a transceiver configured to communicate with a network and a processor communicatively coupled to the transceiver and configured to perform any of the methods of the first through thirteenth examples.

In a sixteenth example, a method performed by a first base station, comprising transmitting configuration information to a user equipment (UE), wherein the first base station operates a first cell deployed on a portion of spectrum that utilizes a shared tiered access and authorization framework and receiving measurement data from the UE corresponding to a second base station, wherein the second base station operates a second cell deployed on the part of the spectrum that utilizes the shared tiered access and authorization framework, wherein the first base station and the second base station are deployed by different network operators and are part of a same tier within the shared tiered access and authorization framework.

In a seventeenth example, the method of the sixteenth example, wherein the first base station performs transmission and reception blanking for a time window during which the UE is configured to collect measurement data corresponding to the second base station.

In an eighteenth example, the method of the sixteenth example, wherein the measurement data comprises receive signal strength indication (RSSI).

In a nineteenth example, the method of the eighteenth example, wherein the RSSI is a linear average of a total received power observed by the UE in configured orthogonal frequency division multiplexing (OFDM) symbols of configured measurement time resources in a configured measurement bandwidth.

In a twentieth example, the method of the sixteenth example, wherein the measurement data comprises a subframe number (SFN) and framing time difference (SFTD) between the network and a second different network.

In a twenty first example, the method of the twentieth example, wherein the SEN and SFTD is comprised of at least a SFN offset and a frame boundary offset.

In a twenty second example, the method of the sixteenth example, further comprising receiving configuration information of the second base station from the UE, the configuration information including a time division duplexing (TDD) configuration for the second base station.

In a twenty third example, the method of the sixteenth example, further comprising receiving configuration information of the second base station from the UE, the configuration information including a bandwidth on which the second base station operates.

In a twenty fourth example, the method of the sixteenth example, wherein the UE is triggered to report the measurement data to the first base station based on identifying that the first base station and the second base station use a different time division duplexing (TDD) configuration.

In a twenty fifth example, the method of the sixteenth example, wherein the UE is triggered to report the measurement data to the first base station based on identifying that the first base station and the second base station belong to a different public land mobile network (PLMN).

In a twenty sixth example, the method of the sixteenth example, wherein the spectrum that utilizes the shared tiered access and authorization framework is citizens broadband radio service (CBRS) and the same tier is general authorized access (GAA).

In a twenty seventh example, the method of the twenty sixth example further comprising transmitting a request to a spectrum access system (SAS) to operate the first cell on a different portion of the CBRS spectrum in response to identifying interference caused by the second base station.

In a twenty eighth example, a processor configured to perform any of the methods of the sixteenth through twenty seventh examples.

In a twenty ninth example, a base station comprising a transceiver configured to communicate with a user equipment (UE) and a processor communicatively coupled to the transceiver and configured to perform any of the methods of the sixteenth through twenty seventh examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
decode, based on signaling received from a first cell of a network, network configuration information, wherein the first cell is operated by a first base station and deployed on a portion of spectrum that utilizes a shared tiered access and authorization framework;
collect measurement data corresponding to a second cell, the second cell operated by a second base station and deployed on the portion of the spectrum that utilizes the shared tiered access and authorization framework, wherein the first base station and the second base station are deployed by different network operators and are part of a same tier within the shared tiered access and authorization framework; and
generate a message to report the measurement data to the network.

2. The apparatus of claim 1, wherein the measurement data comprises receive signal strength indication (RSSI).

3. The apparatus of claim 2, wherein the RSSI is a linear average of a total received power observed by the UE in configured orthogonal frequency division multiplexing (OFDM) symbols of configured measurement time resources in a configured measurement bandwidth.

4. The apparatus of claim 1, wherein the measurement data comprises a subframe number (SFN) and framing time difference (SFTD) between the network and a second different network.

5. The apparatus of claim 4, wherein the SFN and SFTD is comprised of at least a SFN offset and a frame boundary offset.

6. The apparatus of claim 1, wherein the processing circuitry is further configured to:
decode, based on signaling received from the second base station, a system information block (SIB); and
configure transceiver circuitry to report configuration information of the second base station derived from the SIB to the network.

7. The apparatus of claim 6, wherein the configuration information of the second base station derived from the SIB includes a time division duplexing (TDD) configuration for the second base station or a bandwidth on which the second base station operates.

8. The apparatus of claim 1, wherein the UE is triggered to report the measurement data to the network based on identifying that the first base station and the second base station uses a different time division duplexing (TDD) configuration.

9. The apparatus of claim 1, wherein the UE is triggered to report the measurement data to the network based on identifying that the first base station and the second base station belong to a different public land mobile network (PLMN).

10. The apparatus of claim 1, wherein the measurement data is collected during a first measurement gap that is greater than 6 milliseconds (ms) or during a second measurement gap that is configured with a measurement gap periodicity that is greater than 160 milliseconds (ms).

11. The apparatus of claim 1, wherein the spectrum that utilizes the shared tiered access and authorization framework is citizens broadband radio service (CBRS) and the same tier is general authorized access (GAA).

12. An apparatus of a first base station, the apparatus comprising processing circuitry configured to:
generate configuration information for transmission to a user equipment (UE), wherein the first base station operates a first cell deployed on a portion of spectrum that utilizes a shared tiered access and authorization framework; and
decode, based on signaling received from the UE, measurement data corresponding to a second base station, wherein the second base station operates a second cell deployed on a part of the spectrum that utilizes the shared tiered access and authorization framework, wherein the first base station and the second base station are deployed by different network operators and are part of a same tier within the shared tiered access and authorization framework.

13. The apparatus of claim 12, wherein the first base station performs transmission and reception blanking for a time window during which the UE is configured to collect the measurement data corresponding to the second base station.

14. The apparatus of claim 12, wherein the measurement data comprises receive signal strength indication (RSSI).

15. The apparatus of claim 14, wherein the RSSI is a linear average of a total received power observed by the UE in configured orthogonal frequency division multiplexing (OFDM) symbols of configured measurement time resources in a configured measurement bandwidth.

16. The apparatus of claim 12, wherein the measurement data comprises a subframe number (SFN) and framing time difference (SFTD) between a first network and a second different network, wherein the SFN and SFTD is comprised of at least a SFN offset and a frame boundary offset.

17. The apparatus of claim 12, wherein the processing circuitry is further configured to:
decode, based on signaling received from the UE, configuration information of the second base station, the configuration information including a time division duplexing (TDD) configuration for the second base station or a bandwidth on which the second base station operates.

18. The apparatus of claim 12, wherein the UE is triggered to report the measurement data to the first base station based on identifying that the first base station and the second base station belong to a different public land mobile network (PLMN).

19. The apparatus of claim 12, wherein the spectrum that utilizes the shared tiered access and authorization framework is citizens broadband radio service (CBRS) and the same tier is general authorized access (GAA).

20. The apparatus of claim 19, wherein the processing circuitry is further configured to:
generate, for transmission to a spectrum access system (SAS), a request to operate the first cell on a different portion of CBRS spectrum in response to identifying interference caused by the second base station.
